(19) United States
(12) Patent Application Publication
(10) Pub. No.: US 2009/0191331 A1
(43) Pub. Date: Jul. 30, 2009

(54) PERPENDICULAR MAGNETIC RECORDING MEDIUM MANUFACTURING METHOD

(75) Inventors: Teiichiro Umezawa, Singapore (SG); Takahiro Onoue, Singapore (SG); Chikara Takasu, Singapore (SG); Kong Kim, Singapore (SG)

Correspondence Address: SUGHRUE MION, PLLC, 2100 PENNSYLVANIA AVENUE, N.W., SUITE 800, WASHINGTON, DC, 20037, US

(73) Assignees: Hoya Corporation, Shinjuku-ku,TOKYO (JP); Hoya Magnetics Singapore PTE. LTD., Singapore (SG)

(21) Appl. No.: 12/295,550

(22) PCT Filed: Mar. 31, 2007
(86) PCT No.: PCT/JP2007/057316

§ 371 Date: Sep. 30, 2008

(30) Foreign Application Priority Data
Mar. 31, 2006 (JP) 2006-100321

(51) Int. Cl. B05D 5/12

(52) U.S. Cl. 427/130

(57) ABSTRACT

[Object] To provide a manufacturing method that can easily enhance a reversed domain nucleation magnetic field of a magnetic recording layer in a perpendicular magnetic recording medium having, over a substrate, a soft magnetic layer, the magnetic recording layer having a granular structure, and a continuous layer having a high perpendicular magnetic anisotropy.

[Solution] A perpendicular magnetic recording medium manufacturing method according to this invention is characterized by including a soft magnetic layer forming step of forming a soft magnetic layer over a substrate, a magnetic recording layer forming step of forming a magnetic recording layer having a granular structure as an upper layer of the soft magnetic layer, a continuous layer forming step of forming a continuous layer having a perpendicular magnetic anisotropy as an upper layer or a lower layer of the magnetic recording layer, and a heating step of heating a medium, obtained by forming the continuous layer in the continuous layer forming step, for improving a value of a reversed domain nucleation magnetic field.

### TECHNICAL FIELD

This invention relates to a method of manufacturing a perpendicular magnetic recording medium adapted to be mounted in a perpendicular magnetic recording type HDD (hard disk drive) or the like.

### BACKGROUND ART

Various information recording techniques have been developed following the increase in volume of information processing in recent years. Particularly, the areal recording density of HDDs using the magnetic recording technique has been increasing at an annual rate of about 100%. Recently, the information recording capacity exceeding 100 GB has been required per 2.5-inch magnetic disk adapted for use in a HDD or the like. In order to satisfy such a requirement, it is necessary to realize an information recording density exceeding 200 Gbits/inch². In order to achieve the high recording density in a magnetic disk for use in a HDD or the like, it is necessary to reduce the size of magnetic crystal grains forming a magnetic recording layer serving to record information signals, and further, to reduce the thickness of the layer. However, in the case of conventionally commercialized magnetic disks of the in-plane magnetic recording type (also called the longitudinal magnetic recording type or the horizontal magnetic recording type), as a result of the reduction in size of magnetic crystal grains, there has arisen a so-called thermal fluctuation phenomenon where the thermal stability of recorded signals is degraded due to superparamagnetism so that the recorded signals are lost, which has thus become an impeding factor for the increase in recording density of the magnetic disks.

In order to solve this impeding factor, magnetic disks of the perpendicular magnetic recording type have been proposed in recent years. In the case of the perpendicular magnetic recording type, as different from the case of the in-plane magnetic recording type, the easy magnetization axis of a magnetic recording layer is adjusted so as to be oriented in a direction perpendicular to the surface of a substrate. As compared with the in-plane magnetic recording type, the perpendicular magnetic recording type can suppress the thermal fluctuation phenomenon and thus is suitable for increasing the recording density. For example, Japanese Unexamined Patent Application Publication (JP-A) No. 2005-285275 (Patent Document 1) discloses a technique about a perpendicular magnetic recording medium having an adhesive layer, a soft magnetic layer, a seed layer, an underlayer, a perpendicular magnetic recording layer, a medium protective layer, and a lubricating layer that are formed on a substrate in the order named. Further, U.S. Pat. No. 6,468,670 Specification (Patent Document 2) discloses a perpendicular magnetic recording medium having a configuration in which an exchange-coupled artificial lattice film continuous layer (exchange-coupled layer) is adhered to a granular recording layer.
Patent Document 1: Japanese Unexamined Patent Application Publication (JP-A) No. 2005-285275
Patent Document 2: U.S. Pat. No. 6,468,670 Specification

### DISCLOSURE OF THE INVENTION

### Problem to be Solved by the Invention

As described in Patent Document 1, the technique is generally employed wherein a soft magnetic layer is provided below a magnetic recording layer in a perpendicular magnetic recording medium so that a high recording magnetic field is applied to the magnetic recording layer by forming a closed magnetic path starting from a recording head and returning to the recording head through the soft magnetic layer. With this configuration, it is possible to apply a strong magnetic field to a recording track, but since a leakage magnetic field to adjacent tracks increases simultaneously, there arises a problem of WATE (Wide Area Track Erasure), i.e. a phenomenon in which recorded information is lost over several μm centering around a track subjected to writing. This problem is particularly actualized in a format where adjacent tracks are close to each other (i.e. a high recording density format).

As a technique for reducing WATE, it is said to be important to make negative a reversed domain nucleation magnetic field (Hn) of a magnetic recording layer and further to make large an absolute value thereof. In order to obtain a high (absolute value is large) Hn, there has been proposed a CGC (Coupled Granular Continuous) medium with a thin film (continuous layer), that exhibits a high perpendicular magnetic anisotropy, formed above or below a magnetic recording layer having a granular structure, just as described in Patent Document 2.

However, even if the configuration of the CGC medium is simply employed for a perpendicular magnetic recording medium, it is difficult to obtain a sufficient reversed domain nucleation magnetic field Hn that satisfies Hn<-2000 oersteds (Oe).

This invention aims to solve such problems and has an object to provide a perpendicular magnetic recording medium manufacturing method that can easily enhance a reversed domain nucleation magnetic field Hn of a magnetic recording layer in a perpendicular magnetic recording medium having, over a substrate, a soft magnetic layer, the magnetic recording layer having a granular structure, and a continuous layer having a high perpendicular magnetic anisotropy.

### Means for Solving the Problem

In order to solve the above-mentioned problem, a perpendicular magnetic recording medium manufacturing method according to this invention is characterized by including a soft magnetic layer forming step of forming a soft magnetic layer over a substrate, a magnetic recording layer forming step of forming a magnetic recording layer having a granular structure as an upper layer of said soft magnetic layer, a continuous layer forming step of forming a continuous layer having a perpendicular magnetic anisotropy as an upper layer or a lower layer of said magnetic recording layer, and a heating step of heating a medium, obtained by forming said continuous layer in said continuous layer forming step, for improving a value of a reversed domain nucleation magnetic field Hn.

The substrate is preferably a glass that is excellent in heat resistance. As the glass for the substrate, an amorphous glass or a crystallized glass can be used and, for example, there can be cited an aluminosilicate glass, an aluminoborosilicate glass, a soda lime glass, or the like. Among them, the aluminosilicate glass is preferable. When the soft magnetic layer is amorphous, the substrate is preferably the amorphous glass. It is preferable to use a chemically strengthened glass because the rigidity is high.

The surface roughness of the main surface of the substrate is preferably 6 nm or less in Rmax and 0.6 nm or less in Ra defined by JIS. By providing such a smooth surface, a gap between perpendicular magnetic recording layer—soft magnetic layer can be set constant so that it is possible to form a suitable magnetic circuit through magnetic head—perpendicular magnetic recording layer—soft magnetic layer.

The respective layers over the substrate are preferably formed by a sputtering method. When the layers are formed particularly by a DC magnetron sputtering method, uniform film formation is enabled. However, in terms of the mass productivity, it is also preferable to use an in-line type film forming method.

The soft magnetic layer is not particularly limited as long as it is formed of a magnetic body that exhibits the soft magnetic properties and, for example, use can be made of an Fe-based soft magnetic material such as FeTaC-based alloy, FeTaN-based alloy, FeNi-based alloy, FeCoB-based alloy, or FeCo-based alloy, a Co-based soft magnetic material such as CoTaZr-based alloy or CoNbZr-based alloy, an FeCo-based alloy soft magnetic material, or the like.

Further, the soft magnetic layer preferably has as its magnetic property a coercive force (Hc) of 0.01 to 80 oersteds and more preferably 0.01 to 50 oersteds. Further, it preferably has as its magnetic property a saturation magnetic flux density (Bs) of 500 emu/cc to 1920 emu/cc. The thickness of the soft magnetic layer is preferably 5 nm to 1000 nm and more preferably 20 nm to 150 nm. When it is less than 5 nm, there is a case where it becomes difficult to form a suitable magnetic circuit through magnetic head—perpendicular magnetic recording layer—soft magnetic layer, while, when it exceeds 1000 nm, there is a case where the surface roughness increases. Further, when it exceeds 1000 nm, there is a case where the sputtering film formation becomes difficult.

The magnetic recording layer is preferably formed of CoCrPt and a nonmagnetic substance. The nonmagnetic substance may be any substance as long as it is a substance that can form grain boundary portions around magnetic grains so as to suppress or block the exchange interaction between the magnetic grains and that is a nonmagnetic substance not solid-soluble to cobalt (Co). For example, silicon oxide (SiOx), chromium (Cr), chromium oxide (CrO₂), titanium oxide (TiO₂), zirconium oxide (ZrO₂), and tantalum oxide (Ta₂O₅) can be cited as examples. The content of SiO₂ is preferably 3 mol % to 20 mol % and more preferably 5 mol % to 12 mol %. The thickness of the magnetic recording layer is preferably 3 nm or more and more preferably 7 nm to 15 nm.

The continuous layer is preferably formed by stacking an exchange energy control layer in the form of alternate layers of CoB and Pd or Pt and a coupling control layer made of Pd or Pt and serving to couple the exchange energy control layer to the magnetic recording layer. However, the exchange energy control layer is intended to improve the reversed domain nucleation magnetic field Hn and, if Hn can be improved, the exchange energy control layer is not necessarily in the form of the multilayer film. Further, since the magnetic effect does not change, the exchange energy control layer can be disposed above or below the magnetic recording layer. When the exchange energy control layer is formed above the magnetic recording layer, the magnetic recording layer, the coupling control layer, and the exchange energy control layer may be stacked in the order named from below, while, when the exchange energy control layer is formed below the magnetic recording layer, the exchange energy control layer, the coupling control layer, and the magnetic recording layer may be stacked in the order named from below.

The heating step is preferably carried out using a thermostatic bath (heating system) to heat the medium obtained by forming the continuous layer. Such heating of the medium may be performed either in vacuum or in air unless the surface of the medium is contaminated. The heating temperature is preferably about 150° C. to 240° C. and, particularly at about 200° C., it is possible to achieve the balance between the easiness of temperature control and the assurance of constant quality.

### EFFECT OF THE INVENTION

According to this invention, with respect to a perpendicular magnetic recording medium, it is possible to easily enhance a reversed domain nucleation magnetic field Hn and thus to improve the WATE characteristics without largely changing the existing manufacturing process (without degrading the mass productivity).

### BRIEF DESCRIPTION OF THE DRAWINGS

FIG. 1 is a diagram for explaining the configuration of a perpendicular magnetic recording disk according to an embodiment.

FIG. 2 is a diagram for explaining a method of manufacturing the perpendicular magnetic recording disk of FIG. 1.

FIG. 3 is a diagram showing changes in magnetic properties due to heating in a heating step of FIG. 2.

FIG. 4 is a diagram showing the relationship between the heating temperature and the reversed domain nucleation magnetic field.

FIG. 5 is a diagram for explaining the configuration of a perpendicular magnetic recording disk (perpendicular magnetic recording medium) according to a second embodiment.

FIG. 6 is a diagram showing changes in magnetostatic properties due to heating in a heating step.

### DESCRIPTION OF SYMBOLS

1 disk substrate
2 adhesive layer
3 soft magnetic layer
4 orientation control layer
5 underlayer
6 granular layer (magnetic recording layer)
7 continuous layer
8 medium protective layer
9 lubricating layer
10 coupling control layer
11 exchange energy control layer
23 soft magnetic layer
23a first soft magnetic layer
23b spacer layer
23c second soft magnetic layer
25 underlayer
25a first underlayer
25b second underlayer
27 onset layer
29 auxiliary recording layer
S1 disk substrate forming step
S3 soft magnetic layer forming step
S6 granular layer forming step (magnetic recording layer forming step)
S7 coupling control layer forming step (continuous layer forming step)
S8 exchange energy control layer forming step (continuous layer forming step)
S9 heating step

### BEST MODE FOR CARRYING OUT THE INVENTION

### First Embodiment

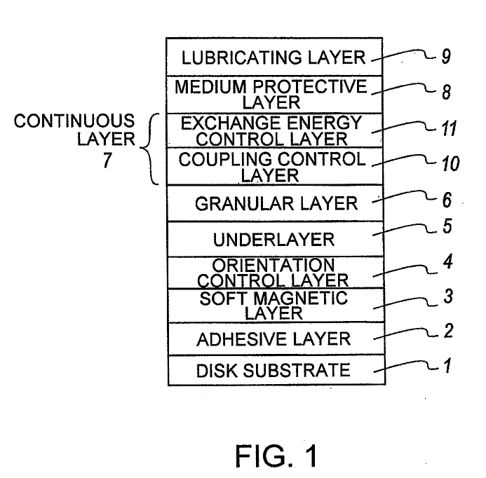

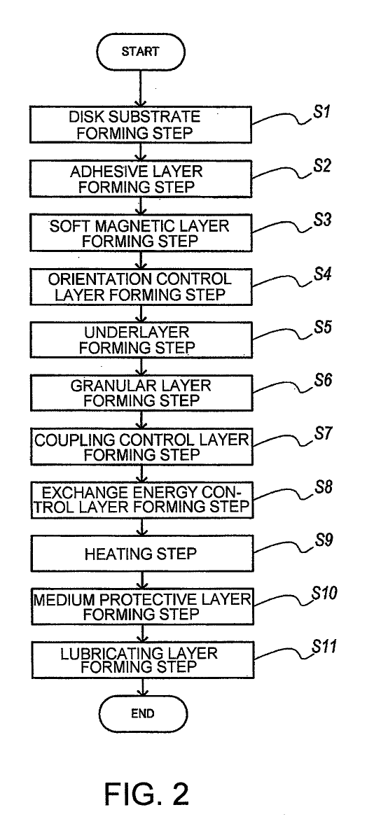

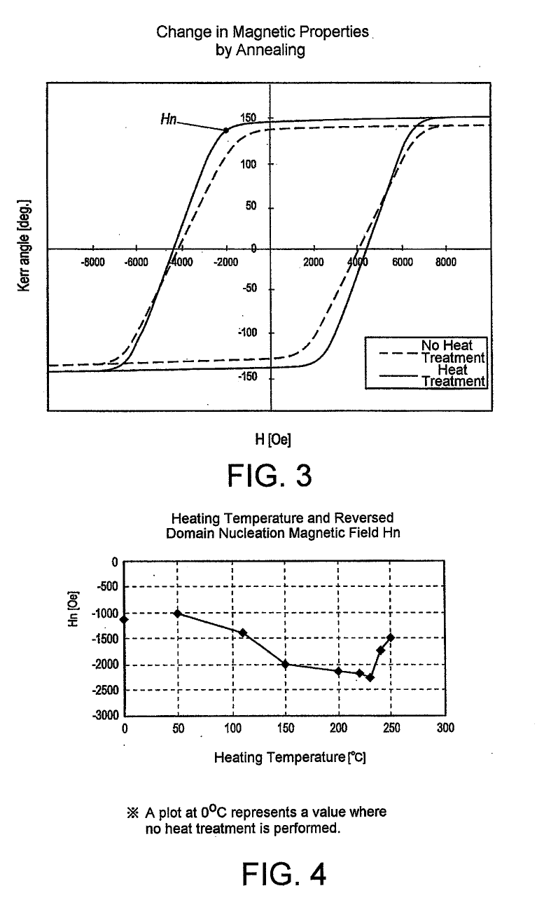

A first embodiment of a perpendicular magnetic recording medium according to this invention will be described with reference to the drawings. FIG. 1 is a diagram for explaining the configuration of a perpendicular magnetic recording disk (perpendicular magnetic recording medium) according to the first embodiment, FIG. 2 is a flowchart for explaining a method of manufacturing the perpendicular magnetic recording disk, FIG. 3 is a diagram showing changes in magnetic properties due to heating in a heating step, and FIG. 4 is a diagram showing the relationship between the heating temperature and the reversed domain nucleation magnetic field Hn. Numerical values given in the following embodiment are only examples for facilitating the understanding of this invention and are not intended to limit this invention unless otherwise stated.

The perpendicular magnetic recording disk shown in FIG. 1 comprises a disk substrate 1, an adhesive layer 2, a soft magnetic layer 3, an orientation control layer 4, an underlayer 5, a granular layer (magnetic recording layer) 6, a continuous layer 7, a medium protective layer 8, and a lubricating layer 9. The continuous layer 7 is composed of a coupling control layer 10 and an exchange energy control layer 11.

For manufacturing this perpendicular magnetic recording disk, at first in a disk substrate forming step (S1), an amorphous aluminosilicate glass was molded into a disk shape by direct press, thereby producing a glass disk having a diameter of 65 mm (2.5 inches). This glass disk was ground, polished, and chemically strengthened in sequence, thereby obtaining the smooth nonmagnetic disk substrate 1 in the form of a chemically strengthened glass disk (step S1: Described as “S1” in FIG. 2. The same shall apply hereinafter.). The surface roughness of the main surface of the disk substrate 1 was measured by an AFM (atomic force microscope) and it was a smooth surface shape with Rmax of 3.0 nm and Ra of 0.25 nm. Rmax and Ra follow Japanese Industrial Standard (JIS).

Using an evacuated film forming apparatus, the layers from the adhesive layer 2 to the continuous layer 7 were formed in sequence on the obtained disk substrate 1 in an Ar atmosphere by a DC magnetron sputtering method (step S2 to step S8). Then, an intermediate product (medium) obtained in step S8 was heated in a thermostatic bath (step S9) and then the medium protective layer 8 was formed by a CVD method (step S10). Thereafter, the lubricating layer 9 was formed by a dip coating method (step S11). Hereinbelow, the structures and specific manufacturing methods of the respective layers will be described.

In the adhesive layer forming step (S2), the adhesive layer 2 was formed using a Ti-alloy target so as to be a Ti-alloy layer of 10 nm. By forming the adhesive layer 2, the adhesion between the disk substrate 1 and the soft magnetic layer 3 can be improved and, therefore, it is possible to prevent stripping of the soft magnetic layer 3. As a material of the adhesive layer 2, use can be made of, for example, a Ti-containing material. In terms of practical use, the thickness of the adhesive layer is preferably set to 1 nm to 50 nm.

In the soft magnetic layer forming step (S3), the soft magnetic layer 3 was formed using a CoTaZr target so as to be an amorphous CoTaZr layer of 50 nm.

In the orientation control layer forming step (S4), the orientation control layer 4 was formed using a Ta target so as to be an amorphous Ta layer having a thickness of 3 nm. In the underlayer forming step (S5), a Ru layer having a thickness of 20 nm was formed as the underlayer 5. The underlayer 5 may be in the form of two layers made of Ru. By forming Ru on the upper layer side at an Ar gas pressure higher than that used when forming Ru on the lower layer side, the crystal orientation can be improved.

In the granular layer forming step (S6), using a hard magnetic target made of CoCrPt and SiO₂ as an example of a nonmagnetic substance, the granular layer 6 with an hcp crystal structure of 10 nm was formed. The nonmagnetic substance may be any substance as long as it is a substance that can form grain boundary portions around magnetic grains so as to suppress or block the exchange interaction between the magnetic grains and that is a nonmagnetic substance not solid-soluble to cobalt (Co). For example, silicon oxide (SiOx), chromium (Cr), chromium oxide (CrO₂), titanium oxide (TiO₂), zirconium oxide (ZrO₂), and tantalum oxide (Ta₂O₅) can be cited as examples.

In the coupling control layer forming step (S7), the coupling control layer 10 was formed by a Pd layer. The coupling control layer 10 can be formed by a Pt layer instead of the Pd layer. The thickness of the coupling control layer 10 is preferably 2 nm or less and more preferably 0.5 to 1.5 nm.

In the exchange energy control layer forming step (S8), the exchange energy control layer 11 is in the form of alternately layered films of CoB and Pd and was formed at a low Ar gas pressure. The thickness of the exchange energy control layer 11 is preferably 1 to 8 nm and more preferably 3 to 6 nm. Using Pt instead of Pd, the exchange energy control layer 11 may be formed by alternately laminating CoB and Pt.

In the heating step (S9), the intermediate product obtained after the formation of the exchange energy control layer 11 was heated in the thermostatic bath at a predetermined temperature for a predetermined time. In this event, the heating temperature is set to a temperature approximately higher than 100° C. and lower than 250° C., which is lower than that in a general annealing treatment, and is preferably set to about 150° C. to 240° C.

Subsequently, in the medium protective layer forming step (S10), the medium protective layer 8 was formed by film formation of carbon by the CVD method while maintaining a vacuum. The medium protective layer 8 is a protective layer for protecting the perpendicular magnetic recording layer from an impact of a magnetic head. Since, in general, carbon formed into a film by the CVD method is improved in film hardness as compared with that by the sputtering method, it is possible to protect the perpendicular magnetic recording layer more effectively against the impact from the magnetic head.

In the lubricating layer forming step (S11), the lubricating layer 9 was formed of PFPE (perfluoropolyether) by the dip coating method. The thickness of the lubricating layer 9 is about 1 nm.

With respect to the perpendicular magnetic recording disk manufactured by the foregoing steps, FIG. 3 shows the measurement results obtained by a Kerr effect measuring apparatus. FIG. 3 shows, as examples, the magnetic properties obtained through the heating step and the magnetic properties obtained not through the heating step (heating temperature in the heating step: 200° C.). As is clear from the same figure, the slope of a hysteresis loop becomes steeper by applying the heat treatment, so that the absolute value of a reversed domain nucleation magnetic field Hn becomes larger.

FIG. 4 shows, in the form of a graph, the relationship between the heating temperature and the reversed domain nucleation magnetic field Hn by changing the heating temperature from 50° C. to 250° C. using the thermostatic bath. As shown in the figure, it is seen that the value of Hn exhibits the heating temperature dependence and is largely improved when the heating temperature is about 150° C. to 240° C., particularly around 230° C. Since the value of Hn is rapidly reduced when the heating temperature exceeds 230° C., it may be very effective, in terms of achieving the balance between the easiness of temperature control and the assurance of constant quality, to manufacture perpendicular magnetic recording media by setting the heating temperature to 200° C. or less.

In the foregoing first embodiment, the heating step was performed immediately after forming the exchange energy control layer 11. However, not limited to this sequence, the same effect can be obtained by applying the heat treatment after forming the medium protective layer 8, the lubricating layer 9, or other films as long as after the formation of the exchange energy control layer 11.

### Second Embodiment

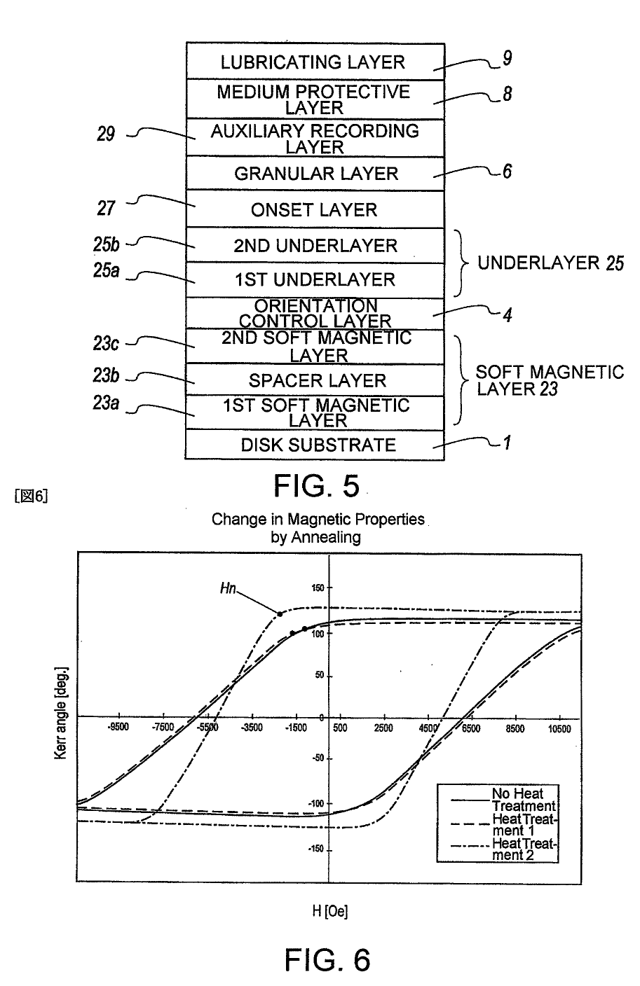

A second embodiment of a perpendicular magnetic recording medium according to this invention will be described with reference to the drawings. FIG. 5 is a diagram for explaining the configuration of a perpendicular magnetic recording disk (perpendicular magnetic recording medium) according to the second embodiment and FIG. 6 is a diagram showing changes in magnetostatic properties due to heating in a heating step. The same symbols are assigned to those portions of which description overlaps that of the foregoing first embodiment, thereby omitting explanation thereof.

The perpendicular magnetic recording disk shown in FIG. 5 comprises a disk substrate 1, a soft magnetic layer 23, an orientation control layer 4, an underlayer 25, an onset layer 27, a granular layer 6 (magnetic recording layer), an auxiliary recording layer 29, a medium protective layer 8, and a lubricating layer 9.

The soft magnetic layer 23 is formed by interposing a nonmagnetic spacer layer 23b between a first soft magnetic layer 23a and a second soft magnetic layer 23c so as to have AFC (antiferro-magnetic exchange coupling). With this configuration, magnetization directions of the first soft magnetic layer and the second soft magnetic layer can be aligned antiparallel to each other with high accuracy, so that it is possible to reduce noise generated from the soft magnetic layer 23. Specifically, the composition of the first soft magnetic layer 23a and the second soft magnetic layer 23c can be CoTaZr (cobalt-tantalum-zirconium) or CoFeTaZr (cobalt-iron-tantalum-zirconium). The composition of the spacer layer 23b is Ru (ruthenium).

The orientation control layer 4 has a function of protecting the soft magnetic layer 23 and a function of facilitating alignment of the orientation of crystal grains of the underlayer 25. The orientation control layer 4 can be a layer of Pt (platinum), NiW (nickel-tungsten), or NiCr (nickel-chromium) having an fcc structure.

The underlayer 25 has a two-layer structure made of Ru. By forming a second underlayer 25b on the upper layer side at an Ar gas pressure higher than that used when forming a first underlayer 25a on the lower layer side, the crystal orientation and the separation of magnetic grains of the granular layer 6 can be simultaneously improved.

The onset layer 27 is a nonmagnetic granular layer. By forming the nonmagnetic granular layer on an hcp crystal structure of the underlayer 25 and growing the granular layer 6 thereon, the nonmagnetic granular layer has a function of separating the magnetic granular layer 6 from an initial stage (buildup). The composition of the onset layer 27 is nonmagnetic CoCrRu—SiO₂ (SiO₂: silicon oxide).

Using a hard magnetic target made of CoCrPt (cobalt-chromium-platinum) and titanium oxide (TiO₂) being a nonmagnetic substance, the granular layer 6 with an hcp crystal structure was formed.

The auxiliary recording layer 29 (continuous layer) is a thin film formed on the granular layer 6 and exhibiting a high perpendicular magnetic anisotropy, thereby forming an exchange energy control layer. With this configuration, in addition to the high-density recording characteristics and the low-noise characteristics of the granular layer 6, it is possible to add high thermal fluctuation resistance of the auxiliary recording layer 29. The composition of the auxiliary recording layer 29 is CoCrPtB.

An intermediate product obtained after the formation of the auxiliary recording layer 29 was heated in a thermostatic bath at a predetermined temperature for a predetermined time. In this event, the heating temperature is set to a temperature approximately higher than 100° C. and lower than 250° C., which is lower than that in a general annealing treatment, and is preferably set to about 150° C. to 240° C.

Like in the foregoing first embodiment, the medium protective layer 8 and the lubricating layer 9 were formed on the auxiliary recording layer 29. Through the manufacturing steps described above, the perpendicular magnetic recording medium was obtained.

The magnetostatic properties of the obtained perpendicular magnetic recording disk were evaluated using a Polar Kerr effect measuring apparatus. The results thereof are shown in FIG. 6 and Table 1. In FIG. 6 and Table 1, Heat Treatment 1 as an Example represents a case subjected to a heating step at 210° C., Heat Treatment 2 as an Example represents a case subjected to a heating step at 240° C., and No Heat Treatment as a Comparative Example represents a case subjected to no heating step. In the figure and the table, Oe is oersteds (representing the intensity of a magnetic field).

TABLE 1

| | Hc | Hn |
|---|---|---|
| | [Oe] | [Oe] |
| No Heat Treatment | 6046 | −1484 |
| Heat Treatment 1 | 6089 | −1528 |
| Heat Treatment 2 | 5143 | −2677 |

As is clear from FIG. 6 and Table 1, the slope of a hysteresis loop becomes steeper by applying the heat treatment, so that the absolute value of a reversed domain nucleation magnetic field Hn becomes larger. As shown, it is seen that the value of Hn exhibits the heating temperature dependence and is slightly improved by raising the heating temperature from No Heat Treatment to Heat Treatment 1 and is largely improved by further raising the heating temperature to Heat Treatment 2.

As described above, according to this invention, it is possible to easily enhance the reversed domain nucleation magnetic field Hn and thus to improve the WATE characteristics without largely changing the existing manufacturing process (without degrading the mass productivity).

### INDUSTRIAL APPLICABILITY

This invention can be used as a method of manufacturing a perpendicular magnetic recording medium adapted to be mounted in a perpendicular magnetic recording type HDD or the like.

1. A perpendicular magnetic recording medium manufacturing method characterized by comprising
a soft magnetic layer forming step of forming a soft magnetic layer over a substrate,
a magnetic recording layer forming step of forming a magnetic recording layer having a granular structure as an upper layer of said soft magnetic layer,
a continuous layer forming step of forming a continuous layer having a perpendicular magnetic anisotropy as an upper layer or a lower layer of said magnetic recording layer, and
a heating step of heating a medium, obtained by forming said continuous layer in said continuous layer forming step, for improving a value of a reversed domain nucleation magnetic field.

2. A perpendicular magnetic recording medium manufacturing method according to claim 1, characterized in that said heating step is performed in a temperature range of 150° C. to 240° C.

3. A perpendicular magnetic recording medium manufacturing method according to claim 1, characterized in that said substrate is a glass.

4. A perpendicular magnetic recording medium manufacturing method according to claim 1, characterized in that said soft magnetic layer is formed of an Fe-based soft magnetic material, a Co-based soft magnetic material, or an FeCo-based alloy soft magnetic material.

5. A perpendicular magnetic recording medium manufacturing method according to claim 1, characterized in that said magnetic recording layer is a ferromagnetic layer of a granular structure containing CoCrPt and a nonmagnetic substance.

6. A perpendicular magnetic recording medium manufacturing method according to claim 1, characterized in that said continuous layer is formed by stacking an exchange energy control layer in the form of alternate layers of a Co-based alloy and Pd or Pt and a coupling control layer made of Pd or Pt and serving to couple said exchange energy control layer to said magnetic recording layer.

7. A perpendicular magnetic recording medium manufacturing method according to claim 1, characterized in that said continuous layer is a single layer made of a magnetic material mainly containing a CoCrPt-based alloy.
